(19) United States
(12) Patent Application Publication
(10) Pub. No.: US 2026/0369300 A1
(43) Pub. Date: Nov. 19, 2026

(54) HEAT-ASSISTED MAGNETIC RECORDING HEADS WITH LOW PRESSURE FLOW CAVITY PROXIMATE NEAR-FIELD TRANSDUCER

(71) Applicant: Seagate Technology LLC, Fremont, CA (US)

(72) Inventors: Michael Allen Seigler, Eden Prairie, MN (US); Pablo Gabriel Levi, Saint Paul, MN (US); James D. Kiely, Edina, MN (US)

(21) Appl. No.: 19/677,152

(22) Filed: May 14, 2026

Related U.S. Application Data
(60) Provisional application No. 63/806,347, filed on May 15, 2025.

(51) Int. Cl. G11B 5/60; G11B 5/012; G11B 5/00

(52) U.S. Cl. CPC G11B 5/6082; G11B 5/012; G11B 2005/0021

(57) ABSTRACT

Described are disk drive recording heads incorporated into sliders having an air-bearing surface that is designed or configured to include one or more features that produce a low pressure and/or low flow region near or around components of the recording head. In particular, the features reduce gas pressure and/or gas flow at or around a near-field transducer, thereby reducing the volume of gas to which the near-field transducer is exposed. This may lead to improved near-field transducer reliability, particularly when the disk drive enclosure includes gases that may react with components of the near-field transducer. Changing the pressure and/or flow of gases across areas of an air bearing surface may include changing air bearing pad shapes and/or locations, and may include altering air bearing mill depths to form channels that produce regions of high or low pressure or gas flow.

### CROSS REFERENCE TO RELATED APPLICATIONS

The present application claims the benefit under 35 U.S.C. § 119(e) of U.S. Provisional Patent Application 63/806,347, filed on May 15, 2025, which is hereby incorporated by reference in its entirety.

### TECHNICAL FIELD

The disclosure relates to recording heads for heat-assisted magnetic recording.

### SUMMARY

In accordance with various aspects, the present disclosure describes sliders for incorporation into heat-assisted magnetic recording disk drives. Such sliders include an air bearing surface configured to face a recording surface of a spinning magnetic media disk during reading and writing of data using the heat-assisted magnetic recording head. The heat-assisted magnetic recording head includes a near-field transducer that extends to the air bearing surface. One or more features of the air bearing surface are disposed and configured to produce low pressure and/or low flow at or around the near-field transducer during operation while the magnetic media disk is spinning adjacent to the air bearing surface.

In certain aspects, the slider has a leading edge at a first end of the air bearing surface and a trailing edge at a second end of the air bearing surface opposite the first end, the leading edge and trailing edge being defined by movement of the slider relative to the spinning magnetic media disk during operation. The recording head may be located proximate to the trailing edge of the slider. At least one of the low pressure and/or low flow features may be positioned at a side of the recording head that is oriented toward the leading edge of the slider. This may include a first feature disposed on a side of the recording head that is oriented toward the leading edge, the first feature formed to have a first depth, and a second feature disposed between the first feature and the near-field transducer, the second feature formed to have a second depth that is different from the first depth.

In certain aspects, features of the air bearing surface are configured to produce low pressure at or around the near-field transducer during operation, and not configured to produce low flow. In certain aspects, features of the air bearing surface are configured to produce low flow at or around the near-field transducer during operation, and not configured to produce low pressure.

In accordance with various aspects, the present disclosure describes disk drives, such as heat-assisted magnetic recording disk drives. The disk drives include a sealed enclosure that encloses a spinning magnetic media disk and a slider suspended at an end of an actuator arm configured to position the slider relative to a recording surface of the magnetic media disk. The slider includes a recording head disposed at or near a trailing edge of the slider, the recording head including a near-field transducer extending to an air bearing surface of the slider, wherein the air bearing surface extends from a leading edge of the slider to the trailing edge of the slider, the air bearing surface configured to face the recording surface of the spinning magnetic media disk during reading and writing of data using the recording head. The slider also includes a feature imparted into the air bearing surface, the feature being disposed and configured to produce low pressure and/or low flow at or around the near-field transducer during operation while the magnetic media disk is spinning adjacent to the air bearing surface.

In certain aspects, the sealed enclosure is filled primarily with an inert gas. In certain aspects, the sealed enclosure encloses a mixture of gases, the mixture of gases including compounds that react with materials that compose the near-field transducer.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a schematic representation of a hard disk drive that may incorporate a recording head in accordance with aspects of the present disclosure.

FIG. 2 is a schematic perspective view of a slider incorporating a recording head in accordance with aspects of the present disclosure.

FIG. 3A is a schematic plane view of an air bearing surface of a slider including features in accordance with aspects of the present disclosure.

FIG. 3B is an enlarged schematic view of the portion of the slider indicated in FIG. 3A.

### DETAILED DESCRIPTION

The present disclosure relates to recording heads for heat-assisted magnetic recording (HAMR), and particularly to recording heads that incorporate a near-field transducer (NFT) that couples electromagnetic energy from a waveguide to thereby induce the generation of plasmons that can be directed at the surface of a magnetic recording medium to aid in magnetic recording. Recording heads are incorporated into a slider that is attached to a suspension at the end of an actuator arm so that the slider can be suspended over the recording surface of magnetic media. As the magnetic media spins, an air bearing is created that allows the slider to “float above” the media surface.

Because the NFT extends to the air bearing surface (or ABS, also known and referred to herein as the media-facing surface), the NFT is exposed to the gases flowing between the slider and the recording media. While hard disk drives (HDDs) that employ HAMR recording heads may be housed in a sealed enclosure filled with an inert gas such as helium (or other controlled environment), small amounts of volatile organic compounds and other reactive molecules may exist in a gaseous form in the enclosure, for example due to outgassing of certain materials or components. As such, the NFT may be exposed to reactants that may prematurely degrade the performance of the NFT. Without loss of generality, the gases or gas mixture inside an HDD may be referred to as “air” or the “atmosphere” inside the drive enclosure.

In accordance with various aspects of the present disclosure, a HAMR recording head may be incorporated into a slider that has an ABS designed to include one or more features that produce a low pressure and/or low flow region near or around the NFT, thereby reducing the volume of gas to which the NFT is exposed, which may lead to improved NFT reliability. Changing the pressure and flow of gases across areas of an air bearing design may include changing air bearing pad shapes and/or locations, and may include altering air bearing mill depths to form channels that produce regions of high or low pressure or gas flow. In accordance with various aspects, the present disclosure provides a modified region near or around the NFT to produce a low pressure and/or low gas flow region at the NFT, thereby exposing the NFT to a smaller amount of the gases in the drive environment. Exposing the NFT to a lower volume of gases over time can slow the rate of reaction of reactive gases to the NFT components, thus improving NFT reliability.

In current ABS designs, the pressure and/or flow is generally higher under the transducer region where the NFT is located to minimize sensitivities of the reader and writer to variations in the manufacturing processes. Increased pressure under the transducer may also be desired to reduce modulation in fly height due to perturbations in head/disk interactions.

While pressure and flow rate are related, ABS designs in accordance with the present disclosure may be targeted at lowering the pressure, the flow rate, or both, near the NFT. In certain aspects, gas flow may be at least partially diverted away from and around the transducer and NFT region of a recording head through the use of milled channels, thereby decreasing the net gas flow near the NFT. Such milled channels or similar features may be used in conjunction with various air bearing pressurization regions, such as in the center pad of the ABS of the slider, to modulate the resultant pressure or flow rate near the NFT.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar. It will also be appreciated that the drawings are meant to illustrate certain aspects and arrangements of features in a way that contributes to their understanding and are not meant to be scale drawings that accurately represent size or shape of elements.

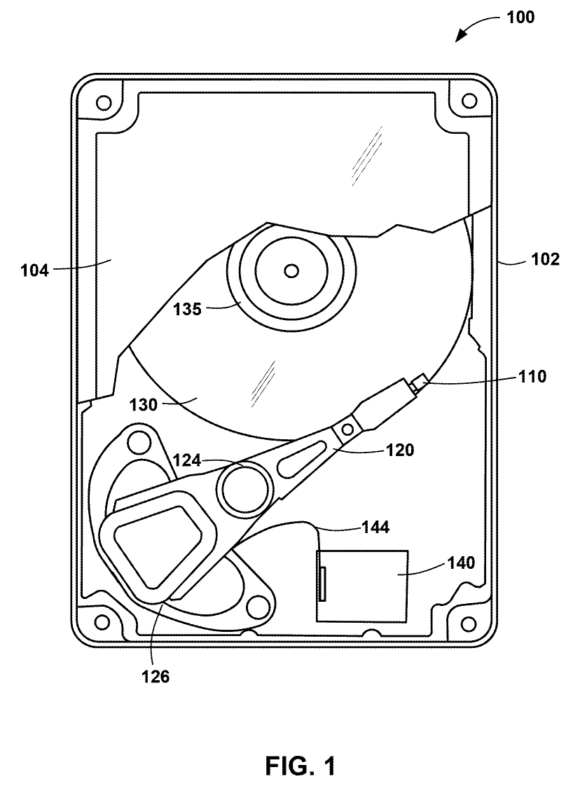

FIG. 1 schematically depicts an example HDD device 100 that includes a recording head (not separately indicated) incorporated on a slider 110, the recording head having read and write capabilities. Slider 110 is disposed on the end of an actuator arm 120 that is rotationally movable around a pivot 124 by use of a voice coil motor 126. Other driving and actuation mechanisms may be used, including piezoelectric motors, linear rail actuators, and so forth. Slider 110 is positioned in close proximity to the surface of magnetic media disk 130 such that the recording head incorporated on the slider can write data to and read data from tracks on the magnetic media 130 as the media disk 130 spins by action of a spindle motor 135. The spinning of the media disk 130 creates an air bearing on which the slider 110 floats above the media surface. The slider 110 includes an ABS that faces the media 135, and the ABS may be designed in accordance with various aspects described herein. For example, the ABS of slider 110 may include features such as channels, milled portions, and so forth, that are designed to reduce the flow and/or pressure of air/gases at or near an NFT component provided in the recording head of slider 110.

Controller electronics 140 may be coupled to the voice coil motor 126 and to the components of the slider 110 via a flex cable 144 that connects to traces (not shown) on the actuator 120. Preamp electronics (not indicated) are typically disposed close to the slider 110 for conditioning signals to and from the recording head. Controller electronics 140 may also be communicatively coupled to spindle motor 135, and thereby control the spinning of the media disk(s) 130 along with the movement of the actuator 120 and the reading and writing of data via the recording head.

The internal components of conventional HDD 100 are contained within an enclosure 102, including cover 104, which is shown partially cut away to reveal the internal components. The enclosure 102 may be sealed and filled with a desired atmosphere, such as an inert gas that may optionally include trace amounts of other gases, to create a controlled environment inside the HDD 100. A host device can communicate with conventional HDD 100 through a standardized interface (not shown). HDD 100 can operate on any magnetic recording principle, whether that be conventional magnetic recording (CMR), shingled magnetic recording (SMR), HAMR, or any other type of recording technique, including combinations thereof.

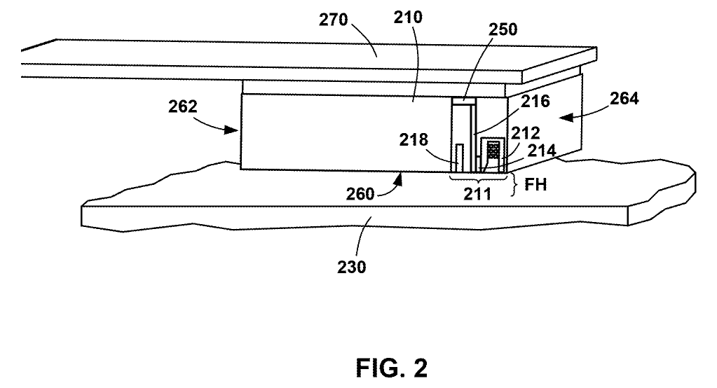

FIG. 2 schematically depicts a slider 210 attached to a suspension 270 for suspending the slider 210 over the surface of a magnetic media disk 230. The direction that the media disk 230 spins under the slider 210 (from left to right in FIG. 2) defines what may be referred to as a leading edge 262 of slider 210 and a trailing edge 264 of slider 210. A HAMR recording head 211 is disposed at or near the trailing edge 264 of slider 210. The recording head 211 includes a read transducer 218 for reading data and a write transducer 212 for writing data, both of which extend to the ABS 260 of slider 210. An NFT 214 is positioned near the write transducer 212, and extends to the ABS 260. A waveguide 216 delivers electromagnetic radiation (such as laser light) from a source 250 (such as a laser) to the NFT 214. The separation between the recording head 211 and the surface of media 230 is called the fly height (FH in FIG. 2). The slider 210 may be slightly canted relative to the surface of media 230 so that the closest distance between the slider 210 and the media 230 is at or near the trailing edge 264. In accordance with various aspects of the present disclosure, ABS 260 includes one or more features that produce low pressure and/or low flow in an area that includes at least the portion of NFT 214 that extends to the ABS 260.

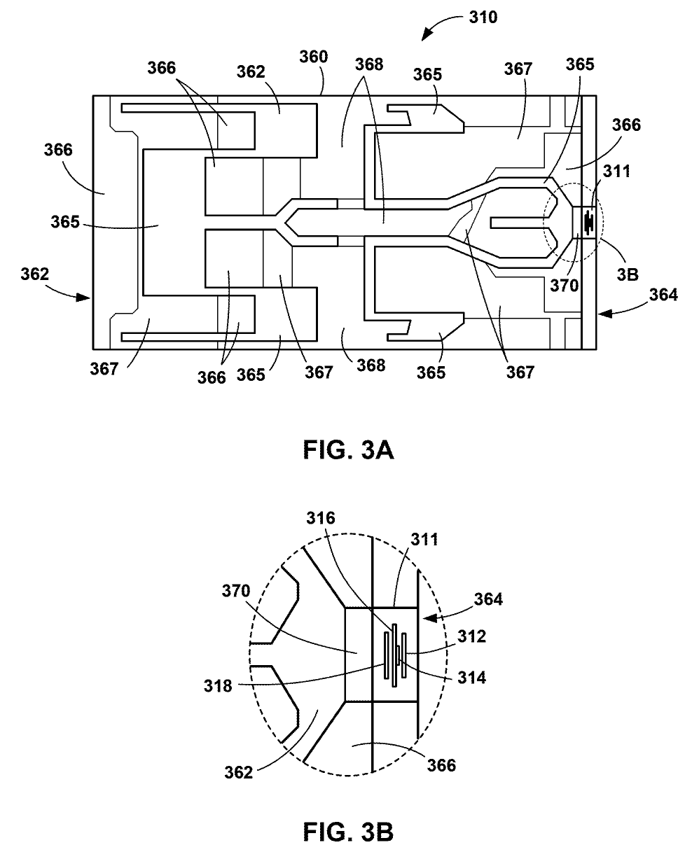

FIG. 3A is a schematic representation of an example ABS 360 of a slider 310, in accordance with certain aspects of the present disclosure. Slider 310 has a leading edge 362 and a trailing edge 364, with HAMR recording head components 311 disposed near the trailing edge 364. The ABS 360 of slider 310 includes various features such as pads and traces 365, milled areas 366 and 367, and channels 368. In this example embodiment, the various features 365, 366, 367, and 368 each have the same (or nearly the same) nominal “depth” (into the page of FIG. 3A) as other features identified by the same reference number. These different depths direct and divert the air/gas flow to maintain the slider 310 at a controllable fly height during operation. In accordance with the present disclosure, an additional feature 370 can be added near the HAMR recording head components 311, and therefore near the NFT. For example, feature 370 can be milled to have a depth that produces a low pressure and/or low flow of air/gases in the area of the NFT during operation. Dashed portion 3B of the ABS 360 of slider 310, which includes the recording head components 311 and additional feature 370, is magnified and shown in FIG. 3B.

In the magnification shown in FIG. 3B, recording head components 311 are indicated, including a write transducer 312, an NFT 314, a waveguide, 316, and a read transducer 318, all of which extend to the ABS. The location, size, shape, and number of additional feature(s), such as feature 370, may be designed to produce a low pressure and/or low flow in the area of the NFT 314 during operation. For example, feature 370 may be a milled area having a depth in a range of about 0.1 microns to about 2 microns, and may span roughly the length of the recording head 311. In certain aspects, feature 370 may extend to areas outside the span of recording head 311. In other aspects, feature 370 may span less than the area of head 311.

Additional features such as feature 370 may also be added to produce low pressure and/or low flow at and around the NFT. For example, a portion of the basecoat region, which is the area between read transducer 318 and feature 370, may be etched or milled to a certain depth, which may be different than the depth of feature 370. Care may need to be taken when etching or milling in the basecoat region to avoid damaging recording head (reader or writer) transducer components that may be buried in that region. The present disclosure contemplates these or any other additional feature that may be useful for reducing pressure and/or flow of gases at or around the NFT.

In some embodiments, the ABS may include at least two distinct features configured to reduce pressure and/or gas flow at or around the NFT. A first feature may be disposed on a side of the recording head oriented toward the leading edge and may be milled or etched to a first depth. A second feature may be disposed between the first feature and the NFT and may be milled or etched to a second depth different from the first depth. The second feature may be formed, at least in part, in a basecoat region between a read transducer and the first feature, and the second depth may be selected to reduce risk of interference with buried transducer components.

Without wishing to be bound by any theory, the following may be taken into account when designing a slider ABS to produce a low pressure and/or gas flow at or around the NFT of a HAMR recording head.

For reactions where gaseous reactants are involved, increasing the pressure usually increases the rate of the reaction. This is because increasing pressure effectively increases the concentration of gas molecules, leading to a higher frequency of collisions between reactant molecules. According to the collision theory, for a reaction to occur, reactant molecules must collide with sufficient energy and in the correct orientation. Higher pressure increases the number of molecules in a given volume, thus increasing the likelihood of collisions, which can lead to more successful reactions. If the reaction rate depends on the concentration of gas molecules, the rate law will reflect how the rate changes with pressure.

For example, taking a reaction for which the rate law can be expressed as Rate = k[A]ⁿ, with [A] being the concentration of reactants and k being the rate constant, if the reaction is first-order with respect to a gas (n=1), then doubling the pressure (which doubles the concentration) would double the reaction rate. In a second-order reaction (n=2), the rate would increase by a factor of four if the pressure is doubled. For reactions where multiple gases are involved, increasing the pressure can also increase the likelihood of collisions between different gas molecules, thus accelerating the reaction. The impact depends on how the concentrations of the different gases change with pressure.

While higher pressure usually increases the rate of reactions involving gaseous reactants, there may be an “optimal” flow rate for maximizing the reaction rate. For heterogeneous reactions (where one reactant is in a different phase, such as a gas reacting with a solid catalyst or surface), increasing the gas flow rate can affect the interaction between the gas molecules and the surface. In this case, the flow rate can influence the availability of reactants at the surface and the residence time of the reactants in the reaction zone. If the flow rate is too high, reactants may pass over the surface too quickly, reducing the time they spend in contact with the catalyst or surface, potentially lowering the reaction rate. If the flow rate is too low, there may not be enough reactant molecules delivered to the surface to sustain a high reaction rate. Mass transfer limitations become important at high gas flow rates. In many reactions, especially those occurring at the interface of phases (such as gas-solid or gas-liquid reactions), the rate of mass transfer (that is, how quickly reactants are transported to the reaction site) can limit the overall reaction rate. In such cases, an increased gas flow rate can improve mass transfer, increasing the rate of reaction.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (for example, all described acts or events may not be necessary to carry out the techniques).

All scientific and technical terms used herein have meanings commonly used in the art unless otherwise specified. The definitions provided herein are to facilitate understanding of certain terms used frequently herein and are not meant to limit the scope of the present disclosure.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality.

As used herein, any term related to position or orientation, such as “proximal,” “distal,” “end,” “outer,” “inner,” and the like, refers to a relative position and does not limit the absolute orientation of an embodiment unless its context of usage clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. A slider including a heat-assisted magnetic recording head, the slider comprising:
an air bearing surface configured to face a recording surface of a spinning magnetic media disk during reading and writing of data using the heat-assisted magnetic recording head, wherein the heat-assisted magnetic recording head includes a near-field transducer extending to the air bearing surface; and
one or more features of the air bearing surface disposed and configured to produce low pressure and/or low flow at or around the near-field transducer during operation while the magnetic media disk is spinning adjacent to the air bearing surface.

2. The slider of claim 1, wherein the slider has a leading edge at a first end of the air bearing surface and a trailing edge at a second end of the air bearing surface opposite the first end, the leading edge and trailing edge being defined by movement of the slider relative to the spinning magnetic media disk during operation.

3. The slider of claim 2, wherein the recording head is located proximate to the trailing edge of the slider.

4. The slider of claim 2, wherein at least one of the one or more features of the air bearing surface disposed and configured to produce low pressure and/or low flow at or around the near-field transducer is positioned at a side of the recording head that is oriented toward the leading edge of the slider.

5. The slider of claim 1, wherein at least one of the one or more features of the air bearing surface disposed and configured to produce low pressure and/or low flow at or around the near-field transducer is positioned proximate to the near-field transducer and formed to have a depth of at least 0.1 microns into the air bearing surface.

6. The slider of claim 1, wherein at least one of the one or more features of the air bearing surface disposed and configured to produce low pressure and/or low flow at or around the near-field transducer is positioned proximate to the near-field transducer and formed to have a depth of about 2 microns or less into the air bearing surface.

7. The slider of claim 2, wherein the one or more features of the air bearing surface disposed and configured to produce low pressure and/or low flow at or around the near-field transducer comprise a first feature disposed on a side of the recording head that is oriented toward the leading edge, the first feature formed to have a first depth, and a second feature disposed between the first feature and the near-field transducer, the second feature formed to have a second depth that is different from the first depth.

8. The slider of claim 7, wherein the second depth is less than the first depth.

9. The slider of claim 7, wherein the first feature has a width that is about the same or greater than a width of the recording head.

10. The slider of claim 7, wherein the second depth is selected to avoid interference with buried recording head components.

11. The slider of claim 7, wherein the first feature is milled or etched to the first depth, and wherein the second feature is milled or etched to the second depth.

12. The slider of claim 1, wherein the recording head further comprises a write transducer and a read transducer.

13. The slider of claim 1, wherein at least one of the one or more features of the air bearing surface is configured to produce low pressure at or around the near-field transducer during operation, and is not configured to produce low flow.

14. The slider of claim 1, wherein at least one of the one or more features of the air bearing surface is configured to produce low flow at or around the near-field transducer during operation, and is not configured to produce low pressure.

15. A disk drive comprising:
a sealed enclosure that encloses a spinning magnetic media disk and a slider suspended at an end of an actuator arm configured to position the slider relative to a recording surface of the magnetic media disk, wherein the slider comprises:
a recording head disposed at or near a trailing edge of the slider, the recording head including a near-field transducer extending to an air bearing surface of the slider, wherein the air bearing surface extends from a leading edge of the slider to the trailing edge of the slider, the air bearing surface configured to face the recording surface of the spinning magnetic media disk during reading and writing of data using the recording head; and
a feature imparted into the air bearing surface, the feature being disposed and configured to produce low pressure and/or low flow at or around the near-field transducer during operation while the magnetic media disk is spinning adjacent to the air bearing surface.

16. The disk drive of claim 15, wherein the sealed enclosure is filled primarily with an inert gas.

17. The disk drive of claim 15, wherein the sealed enclosure encloses a mixture of gases, the mixture of gases including compounds that react with materials that compose the near-field transducer.

18. The disk drive of claim 15, wherein the disk drive is a head-assisted magnetic recording disk drive.

19. The disk drive of claim 15, wherein the feature is milled or etched into the air bearing surface.

20. The disk drive of claim 15, wherein the feature comprises a first feature formed to have a first depth and a second feature formed to have a second depth different from the first depth, the second feature being disposed between the first feature and the near-field transducer.
